(19) United States
(12) Patent Application Publication
(10) Pub. No.: US 2015/0206348 A1
(43) Pub. Date: Jul. 23, 2015

(54) RECEPTION DEVICE

(71) Applicants: Hiroyuki Koreeda, Tokyo (JP); Satoshi Iimuro, Tokyo (JP)

(72) Inventors: Hiroyuki Koreeda, Tokyo (JP); Satoshi Iimuro, Tokyo (JP)

(73) Assignee: HITACHI MAXELL, LTD., Osaka (JP)

(21) Appl. No.: 14/416,336

(22) PCT Filed: Sep. 7, 2012
(86) PCT No.: PCT/JP2012/072836

§ 371 Date: Jan. 22, 2015

(51) Int. Cl. G06T 19/00; G06T 7/00; H04N 5/265

(52) U.S. Cl. CPC G06T 19/006; H04N 5/265; G06T 7/0051

(57) ABSTRACT

Provided are a content display device that presents meta-information that is related to an object in a video and that is tied to position information while presenting a video content, and a content display method. Video image information and AR information including the AR tag, acquisition location information enabling the acquisition of information related to the object by accessing a server storing the information, time information about the start and end of a video image, and position information indicating the display position of the AR tag in the video image at the time information intervals are transmitted. The video image information and the AR information that have been transmitted are received.

### TECHNICAL FIELD

The present invention relates to a technology for displaying with AR (Augmented Reality) information (information about augmented reality) superimposed on a video received and displayed by broadcasting or communication.

### BACKGROUND ART

Patent Literature 1 describes that the AR information on an object, which exists around an information terminal, is acquired from a server over the Internet based on position information which is detected by a GPS or the like of the information terminal, and the AR information is displayed by superimposing it on an image which is photographed and displayed by a camera of the information terminal.

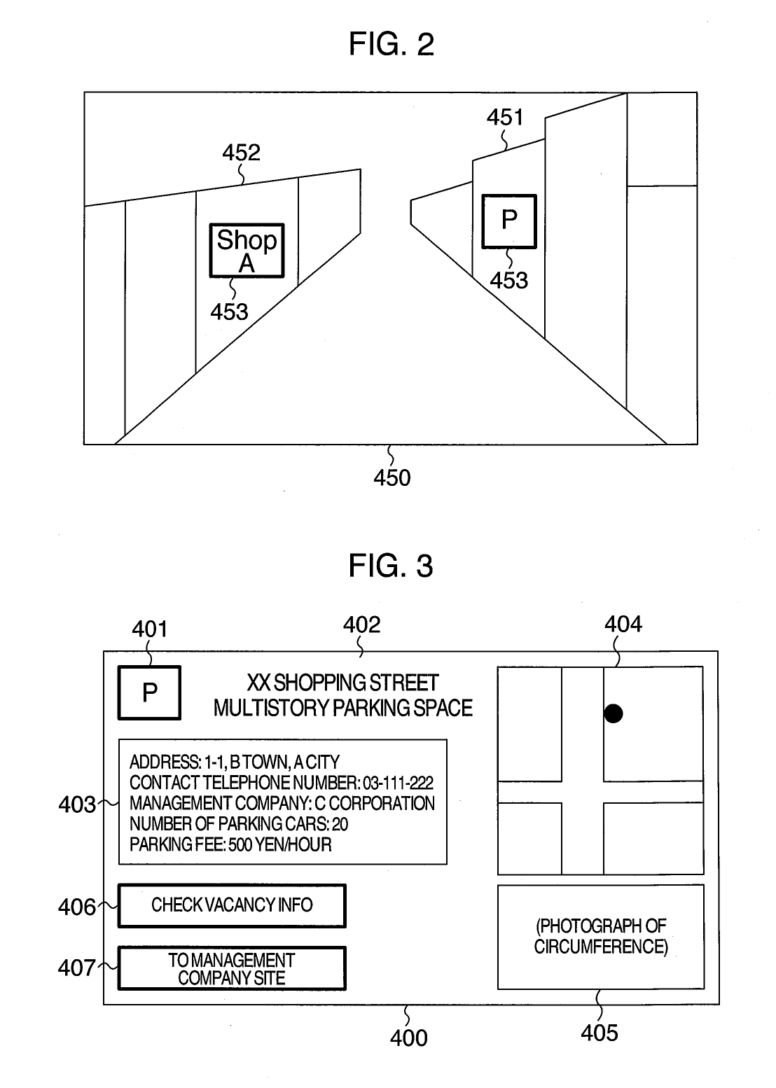

For example, the photographed video of FIG. 2 shows that AR information 453 is superimposed on buildings 451 and 452.

Here, for example, when “P” in the AR tag 453 is touched on the display screen, detail information 400 on “P” (parking lot) is displayed as shown in FIG. 3.

FIG. 3 shows an icon 401 indicating the parking lot, an object's name 402, detail text information 403 on the object, map information 404 indicating the object place, photo information 405 on the object, a link 406 to a Web site where the empty parking space information can be checked, and a link 407 to a Web site of the parking lot management company, and the individual Web sites can be viewed by selecting the link 406 or 407.

As described above, relevant information can be acquired about the object in the video photographed by the camera of the information terminal according to the invention of Patent Literature 1.

### CITATION LIST

### Patent Literature

PATENT LITERATURE 1: JP-A-10-267671

### SUMMARY OF INVENTION

### Technical Problem

However, Patent Literature 1 does not disclose that the AR information (info) is displayed by superimposing it not on the video photographed by the camera but on the video received and displayed by broadcasting or communications.

### Solution to Problem

To solve the above-described subjects, for example, the structure described in claims is adopted.

### Advantageous Effects of Invention

According to the present invention, the AR information can be displayed by superimposing on a video image which is displayed by receiving broadcasting and showing as it is or recording and playing back, or a video image which is displayed by streaming by communication or downloading and playing back, and by selecting it, relevant information of an object in the video image can be acquired.

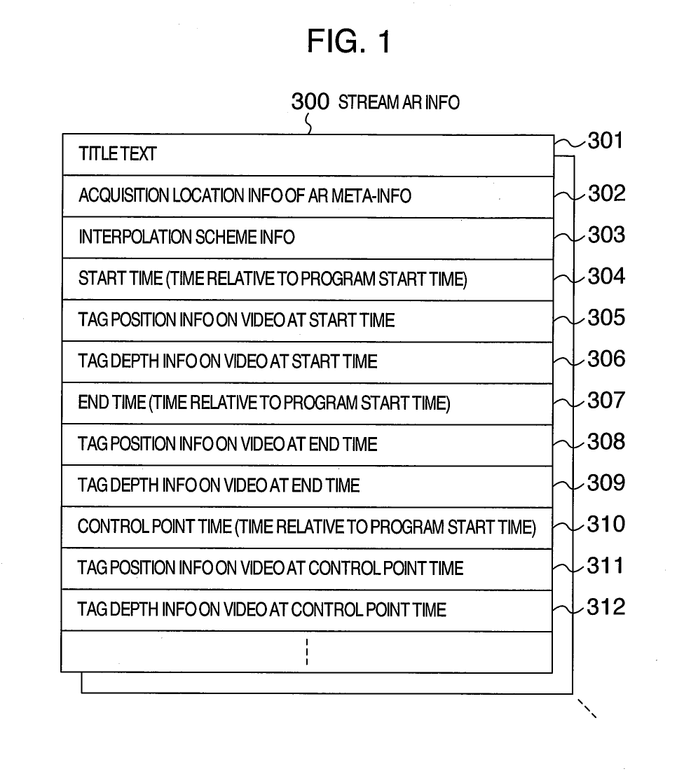

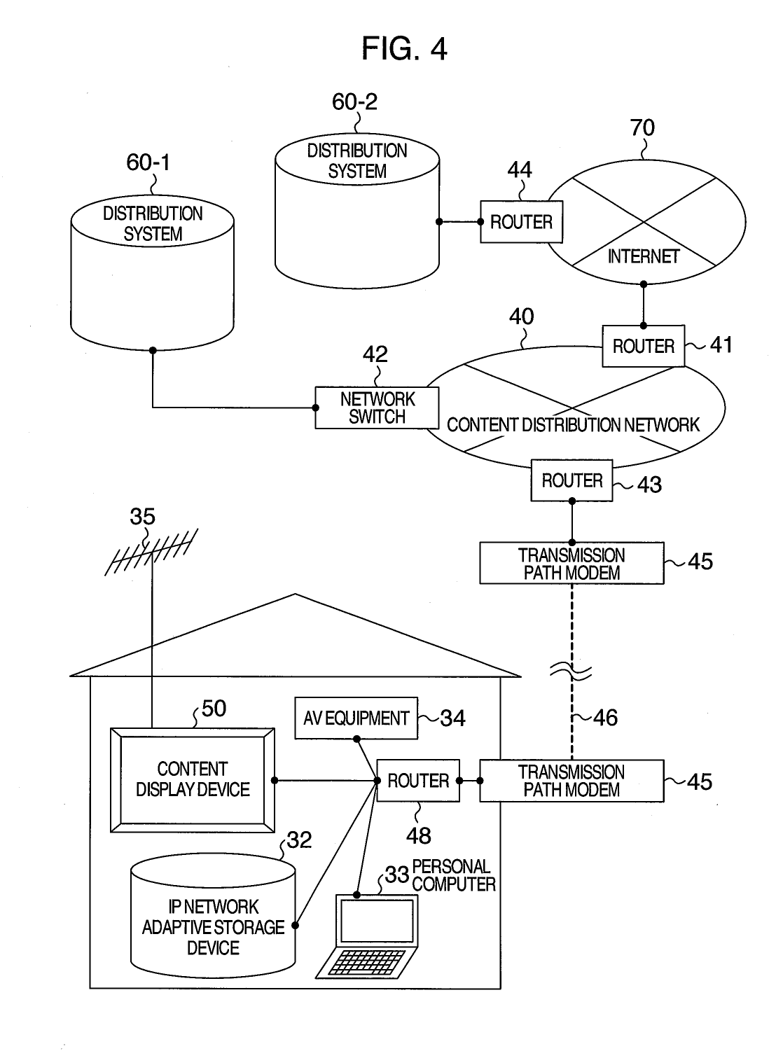

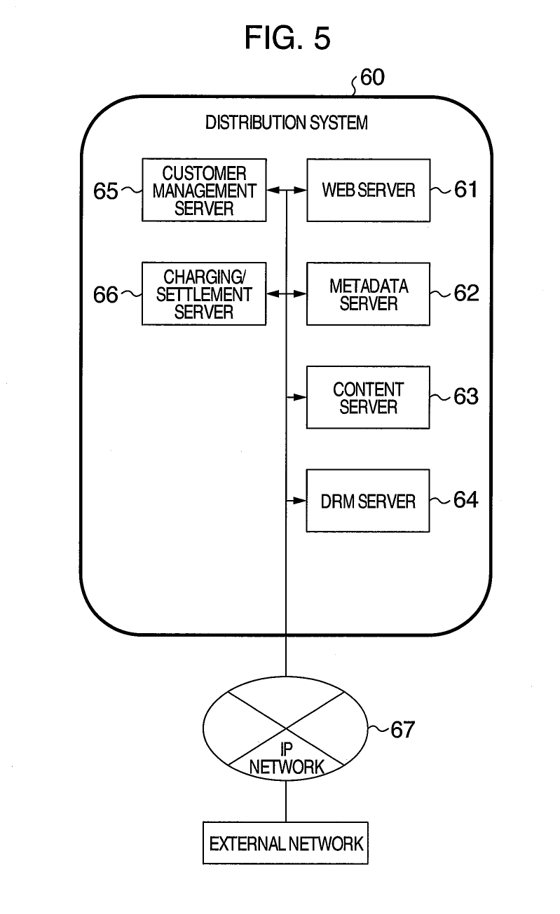

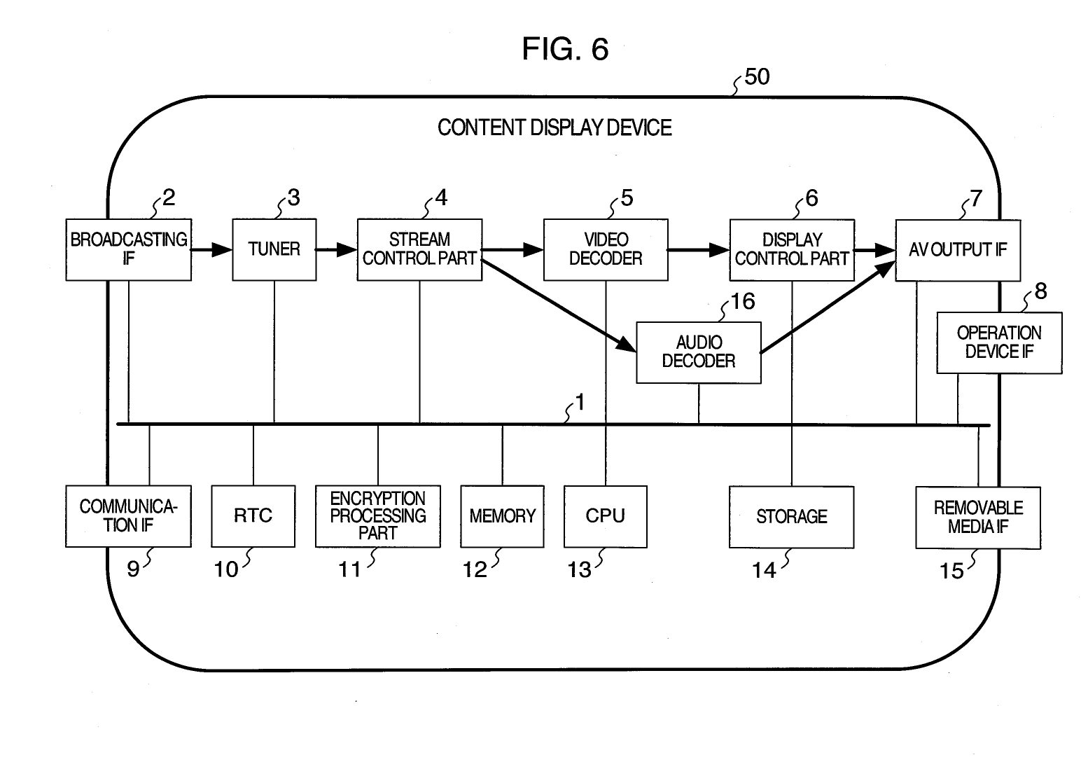

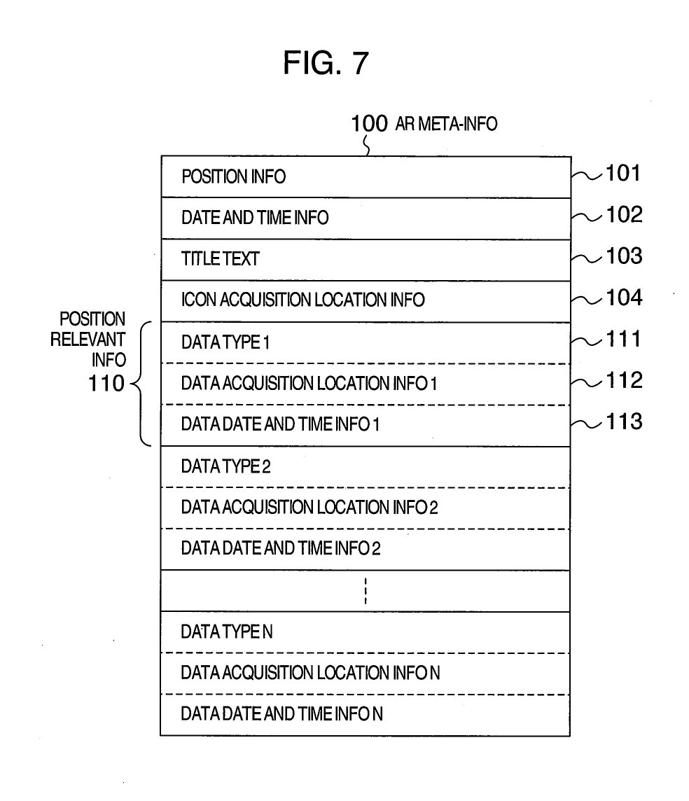

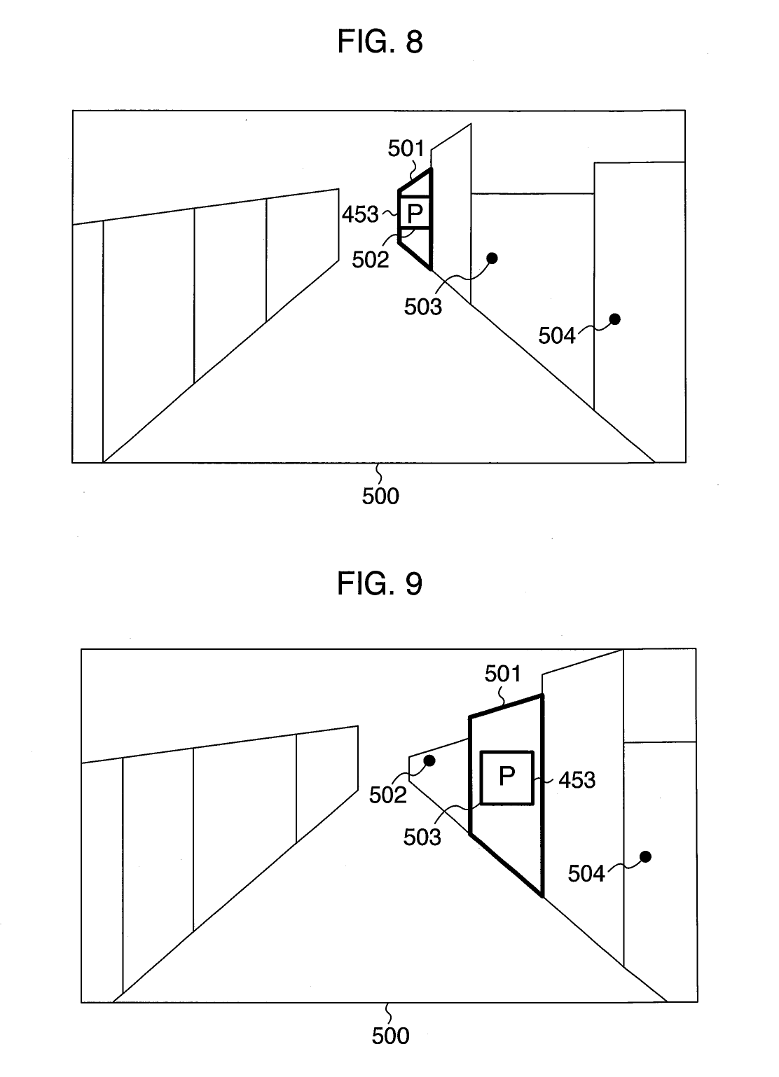

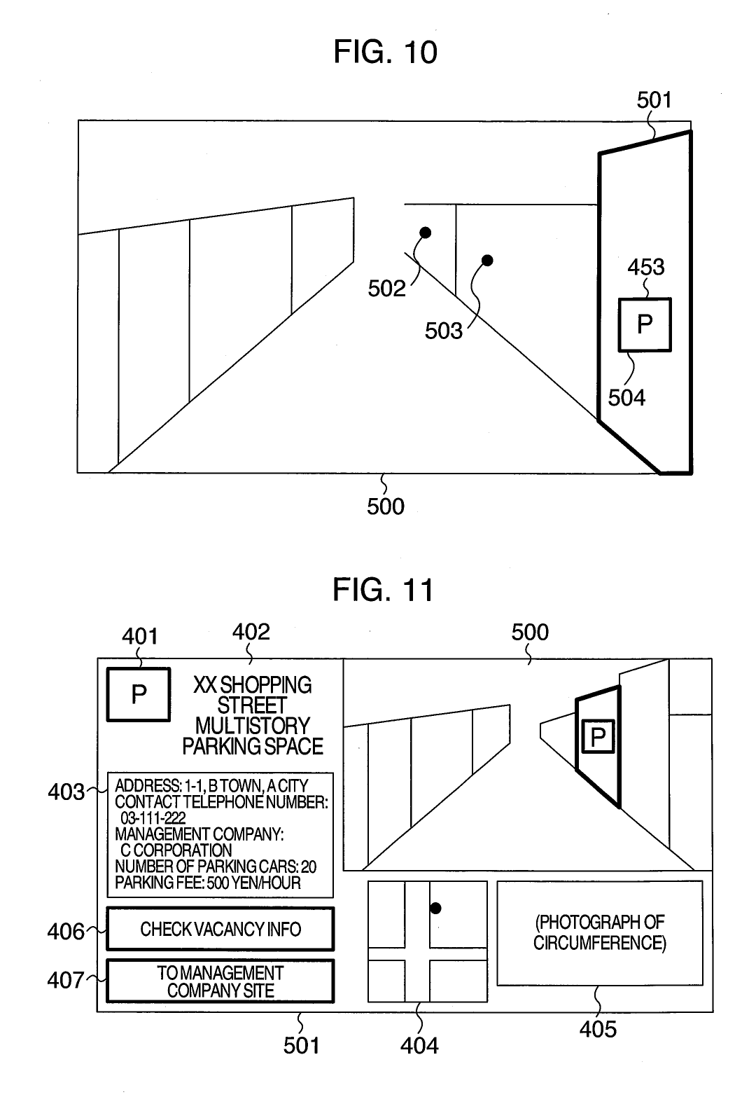

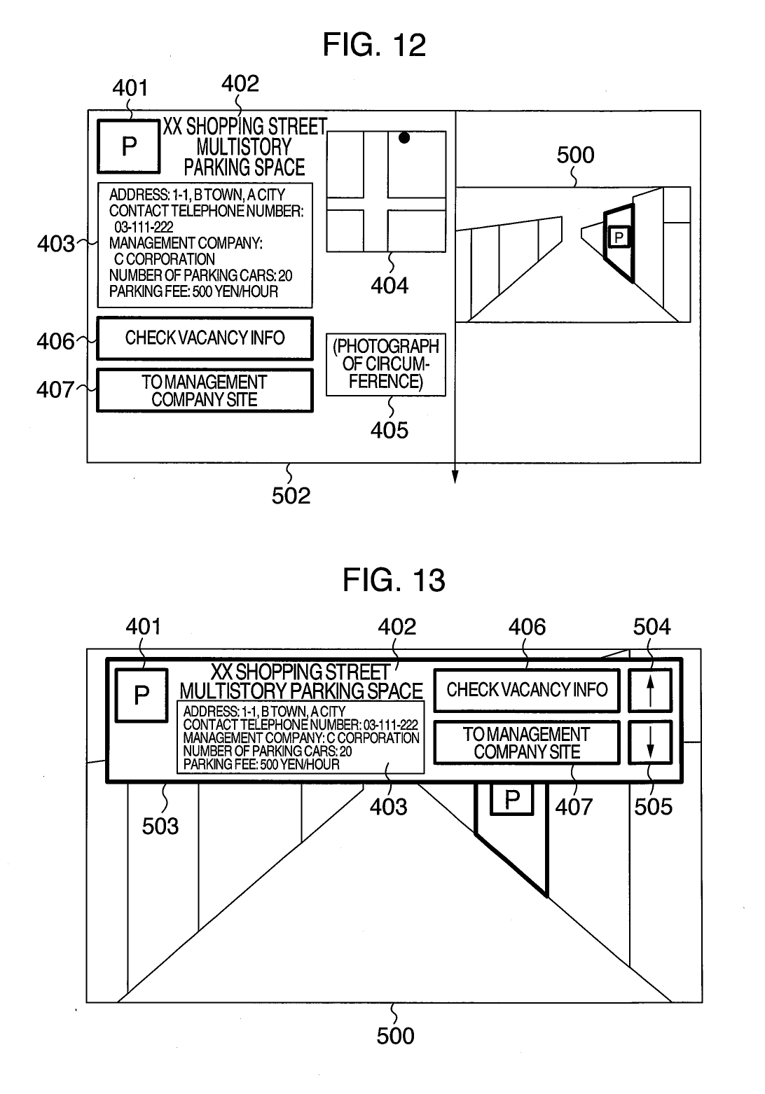

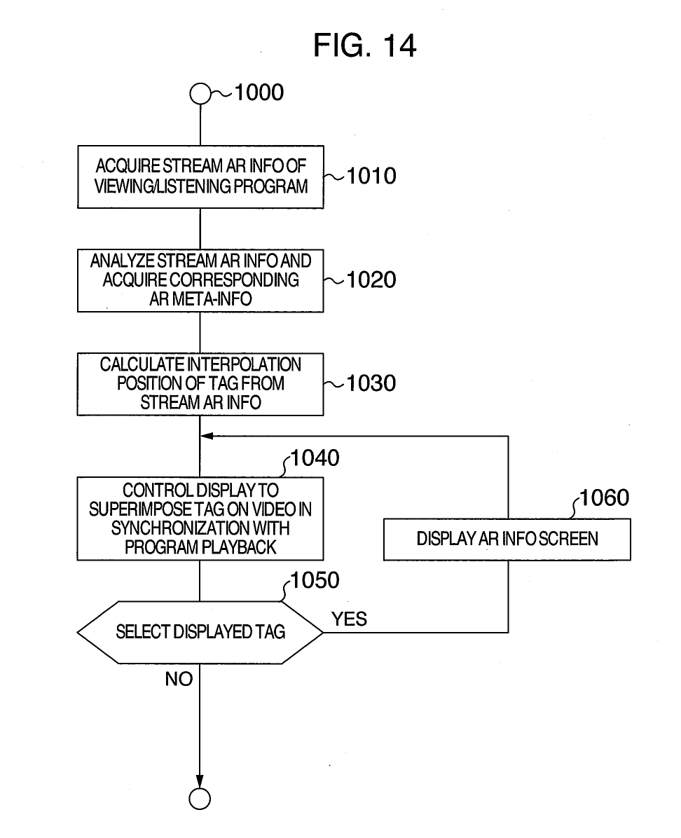

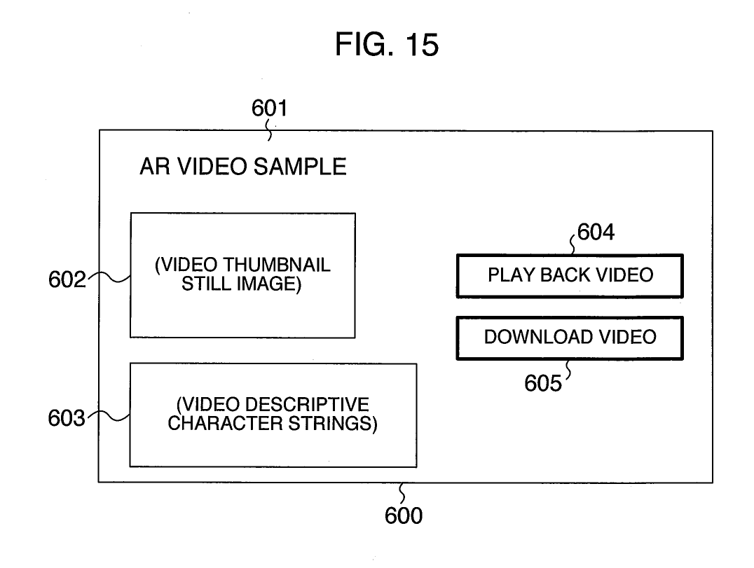

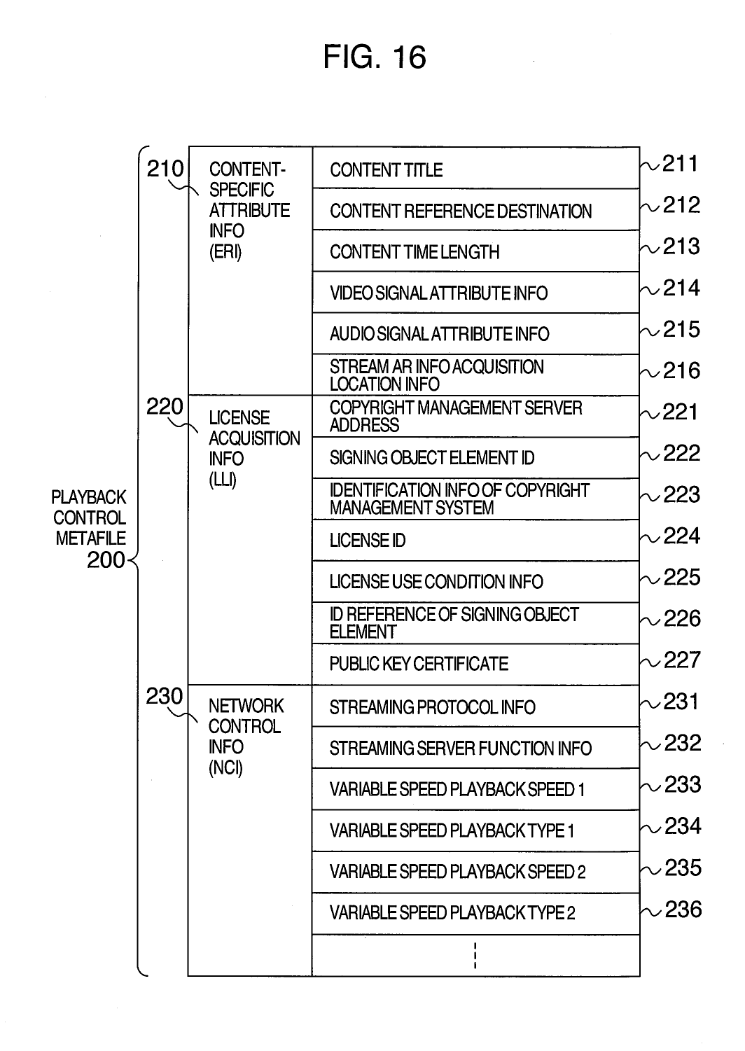

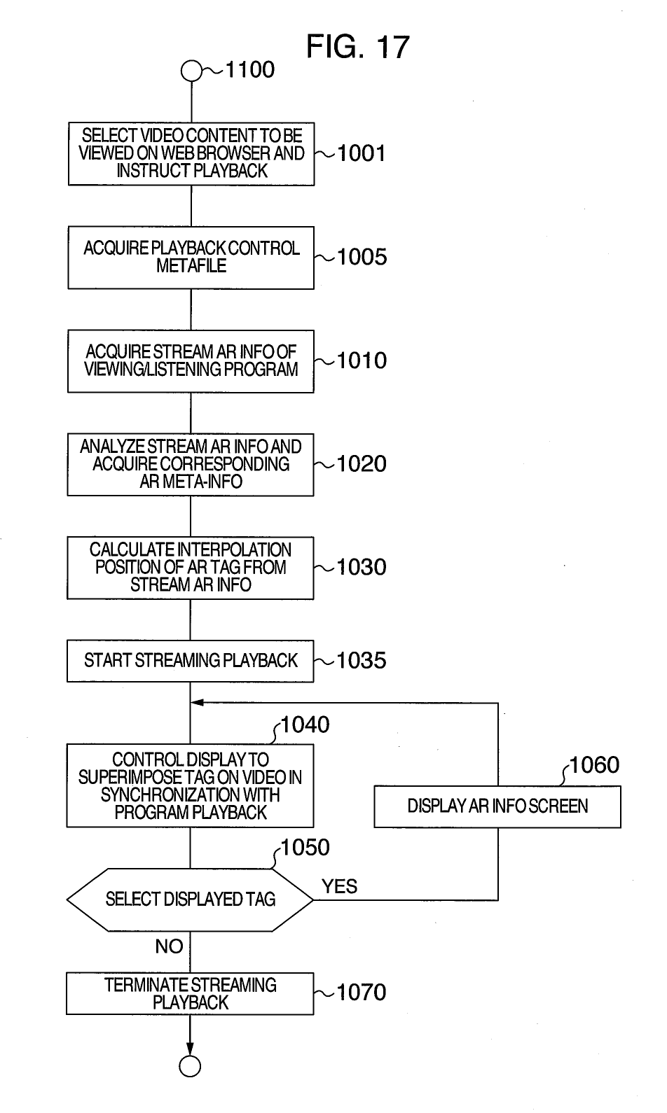

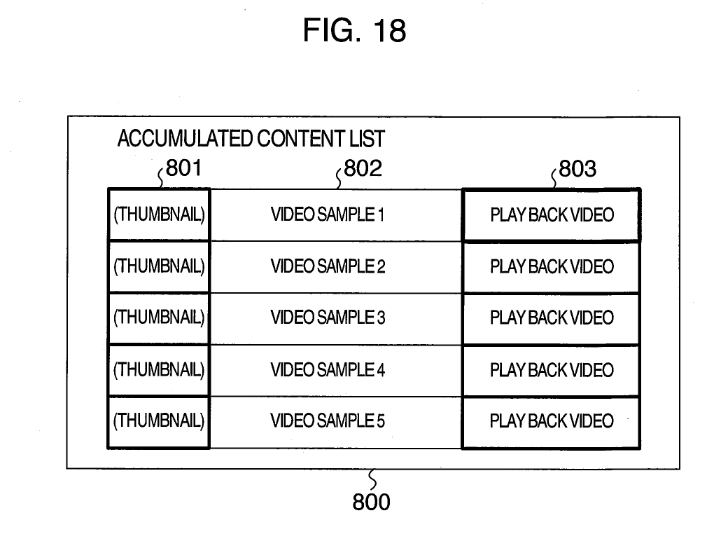

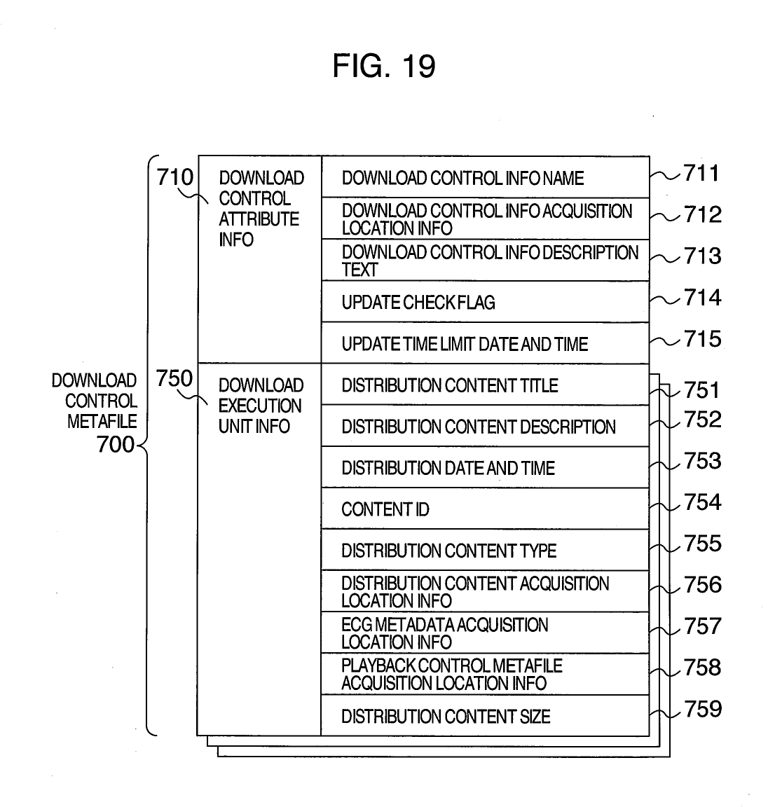

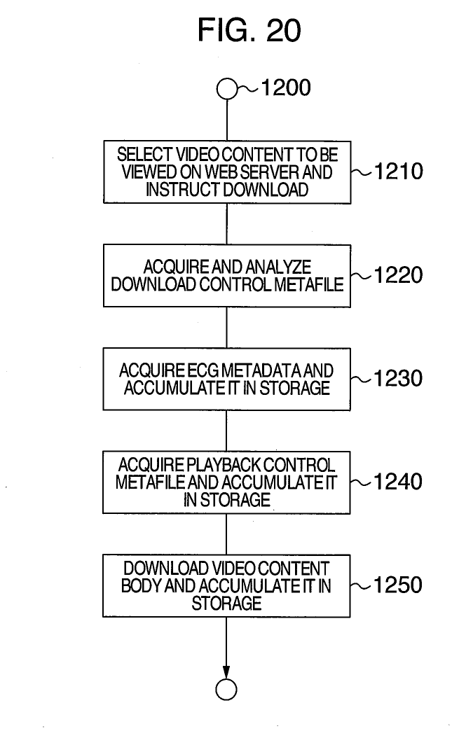

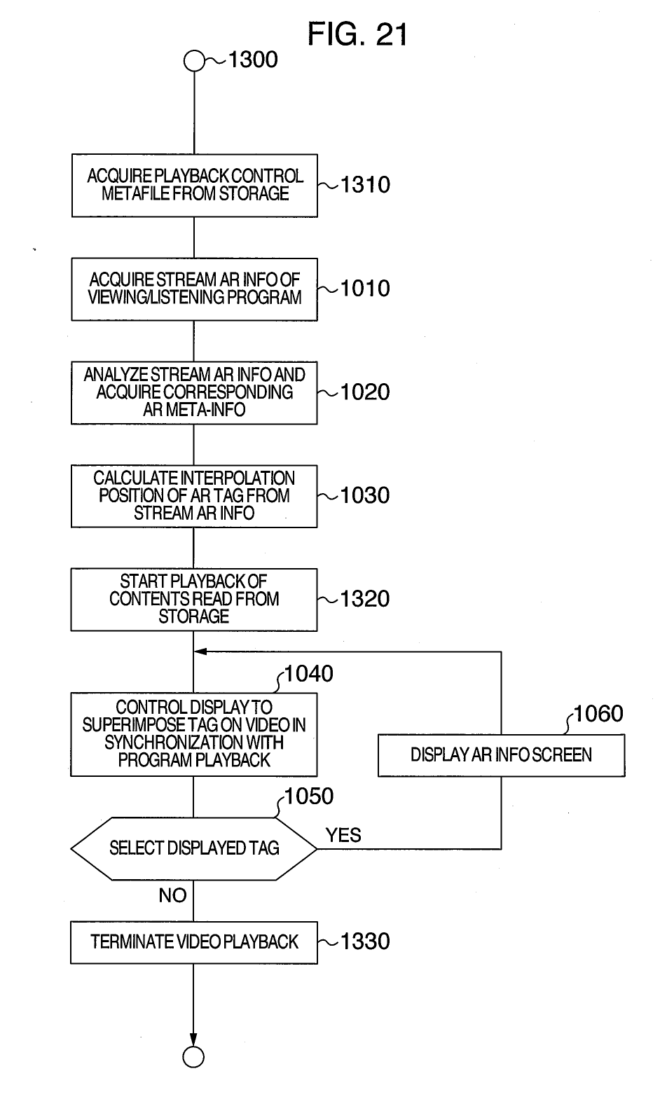

### BRIEF DESCRIPTION OF DRAWINGS

[FIG. 1] A structure example of stream AR information.

[FIG. 2] A display example of an AR service.

[FIG. 3] A display example of an AR information screen.

[FIG. 4] A structure example of a content transmission/reception system.

[FIG. 5] A structure example of a distribution system.

[FIG. 6] A structure example of a content display device.

[FIG. 7] A structure example of AR meta-information.

[FIG. 8] A display example part 1 of a broadcasting-linked AR service of the content display device.

[FIG. 9] A display example part 2 of a broadcasting-linked AR service of the content display device.

[FIG. 10] A display example part 3 of a broadcasting-linked AR service of the content display device.

[FIG. 11] A display example part 1 of a broadcasting-linked AR information screen of the content display device.

[FIG. 12] A display example part 2 of a broadcasting-linked AR information screen of the content display device.

[FIG. 13] A display example part 3 of a broadcasting-linked AR information screen of the content display device.

[FIG. 14] A broadcasting reception processing flow example of the content display device.

[FIG. 15] A display example of a Web browser of the content display device.

[FIG. 16] A structure example of a playback control metafile.

[FIG. 17] A processing flow example of a streaming playback.

[FIG. 18] A display example of an accumulated content list screen of the content display device.

[FIG. 19] A structure example of a download control metafile.

[FIG. 20] A download processing flow example of video contents of the content display device.

[FIG. 21] A processing flow example of accumulated video playback of the content display device.

### DESCRIPTION OF EMBODIMENTS

Embodiments are described below with reference to the drawings.

### Embodiment 1

Embodiment 1 describes a system that receives broadcasting and displays an AR tag in linkage with broadcasting while playing back.

FIG. 4 is a structure example of a content transmission/reception system. A distribution network consists of a content distribution network 40 which guarantees network quality, and an external Internet network 70 which is connected to the content distribution network 40 via a router 41, and the content distribution network 40 is connected to a home via a router 43.

A distribution system 60 has a distribution system 60-1 which is connected to the content distribution network 40 via a network switch 42, and a distribution system 60-2 which is connected via a router 44 to the Internet network 70 of which versatility is emphasized. There may be a type having only one of the distribution systems 60-1 and 60-2.

The network is connected to homes through various communication paths 46 such as a coaxial cable, an optical fiber, an ADSL (Asymmetric Digital Subscriber Line), radio communication or the like, and modulation/demodulation suitable for the individual paths is performed by a transmission path modulator/demodulator (modem) 45 to convert to an IP (Internet Protocol) network.

Equipment in the home is connected to the content distribution network 40 via the router 43, the transmission path modem 45, and a router 48. The equipment in the home includes, for example, a content display device 50, a storage device (Network Attached Storage) 32 corresponding to an IP network, a personal computer 33, AV equipment 34 which is connectable to the network, etc. The content display device 50 may also have both functions to play back and to accumulate the broadcast received via an antenna 35.

FIG. 5 is a structure example of the content distribution system. The content distribution system 60 includes a Web server 61, a metadata server 62, a content server 63, a DRM server 64, a customer management server 65, and a charging/settlement server 66, and the individual servers are connected to one another through an IP network 67, and connected to the Internet network 70 or the content distribution network 40 of FIG. 1 over the IP network 67.

The Web server 61 distributes Web documents. The metadata server 62 distributes ECG (Electric Content Guide) metadata which describes attribute information and the like of the contents to be distributed, and metadata such as a playback control metafile 200 which describes information necessary to play back the contents, a download control metafile 700 which is necessary to download the contents and their attached information, AR meta-information 100 which is linked to position information, stream AR information 300 which describes a relationship between a video content and the AR meta-information 100, etc. And, the playback control metafile 200, the stream AR information 300 or the like which is in one-to-one correspondence with the contents may be distributed from the content server 63.

The content server 63 distributes a content body. The DRM server 64 distributes a license which includes information about a right of using the contents and a key necessary for decryption of the contents. The customer management server 65 manages customer information of a distribution service. The charging/settlement server 66 performs charging or settlement processing of the content by the customer.

Further, it may be configured that a part or all of the above individual servers is directly connected to the Internet network 70 or the content distribution network 40 without through the IP network 67 to perform communications mutually.

And, the above plurality of servers may be merged or eliminated arbitrarily.

And, a separate server may be configured for each type of data.

FIG. 6 is a structure example of a content display device. Thick line arrows indicate a flow of the video content.

The content display device 50 consists of a broadcasting IF (Interface) 2, a tuner 3, a stream control part 4, a video decoder 5, a display control part 6, an AV output IF 7, an operation device IF 8, a communication IF 9, an RTC (Real Time Clock) 10, an encryption processing part 11, a memory 12, a CPU (Central Processing Unit) 13, a storage 14, a removable media IF 15, and an audio decoder 16, and they are connected through a system bus 1.

The broadcasting IF 2 inputs a broadcasting signal. The tuner 3 performs demodulation and decryption of the broadcasting signal. The stream control part 4, if the broadcasting signal is encrypted, decrypts the code and extracts a multiplexed packet from the broadcasting signal. The video decoder 5 decrypts the extracted video packet. The audio decoder 16 decrypts the extracted voice packet. Thus, the broadcasting is played back. The display control part 6 displays the video video generated by the video decoder 5 and the graphics generated by the CPU 13 by converting to a video signal. The AV output IF 7 outputs the video signal generated by the display control part 6, and the voice signal generated by the audio decoder 16 to an external television set or the like.

Also, the AV output IF 7 may be a video/audio integrated IF such as HDMI (High-Definition Multimedia Interface) or a video and audio independent IF such as a composite video output terminal and an optical output audio terminal. And, it may be configured to include a display device and an audio output device within the content display device 50.

The display device may be a device which can stereoscopically display, and in such a case, the video decoder 5 can decrypt a stereoscopic video signal contained in the broadcasting signal, and the display control part 6 outputs the decrypted stereoscopic video signal to the AV output IF 7.

The communication IF 9 establishes physical connection to the IP network and transmits/receives an IP data packet. At that time, processing of various IP communication protocols such as a TCP (Transmission Control Protocol), a UDP (User Datagram Protocol), a DHCP (Dynamic Host Configuration Protocol), a DNS (domain name server), and an HTTP (Hyper Text Transfer Protocol) is performed.

The RTC 10 manages a time of the content display device 50, and when a timer operation of the system or use of the content by time is restricted, also performs its management.

The encryption processing part 11 performs, at a high speed, processing for encryption and decryption of a code, which is applied for protection of the content and communication transmission paths.

After the video content is received from the content server 63 on the connected network via the communication IF 9 and decryption by the encryption processing part 11, it is input to the stream control part 4, and then stream playback of the video can be performed by the same operation as the reception of broadcasting.

The storage 14 is a large capacity storage device such as an HDD for accumulating the contents, metadata, management information, etc. And, the removable media IF 15 is an IF for a memory card, a USB memory, a removable HDD, or an optical media drive.

An operation device which is connected to the operation device IF 8 is considered to be a touch device of an infrared remote controller, a smartphone, etc., a mouse, a voice recognition unit, etc.

Also, the content display device 50, which does not have a broadcast receiving function and receives only the video distribution from the Internet, sends a video and audio stream, which was received from the communication IF 9, to the stream control part 4 through the bus 1, so that the broadcasting IF 2 and the tuner 3 may be omitted. And, the storage 14 and the removable media IF 15 may also be omitted from the content display device 50 which does not use them by applications.

The respective structure elements of the content display device 50 may be made into hardware together in part or all. And, the tuner 3, the stream control part 4, the video decoder 5, the audio decoder 16, and the encryption processing part 11 may be made into software in part or all. In this case, a prescribed processing program is executed by the CPU 13 and the memory 12.

To simplify the description, each processing to be realized when each type of program is executed by a central control part or the like is described below mainly referring to the respective processing parts which are realized by the program. Also, when the respective processing parts are realized by hardware, the respective processing parts mainly execute the respective processing.

A video content which is received by the above content display device 50 from broadcasting or the content server 63 on the network is distributed in a video format such as a TS (Transport Stream) or a PS (Program Stream).

Especially, in case of the TS format, all data is divided and multiplexed in a fixed unit which is called a TS packet, and a series of video packets and voice packets are respectively decrypted by the video decoder 5 and the audio decoder 16, so that video and audio of the video can be played back. And, in addition to the video and audio packets, data and the like associated with a channel selection operation, display of a program table, and programs are multiplexed as SI (Service Information) information, included into the content, and can be distributed.

FIG. 7 is a structure example of the AR meta-information 100 describing an AR tag ([P] and [shop A] of FIG. 2) for realizing AR applications shown in FIG. 2 and FIG. 3. Also, the AR meta-information 100 is generally described as XML format metadata but may be in a binary format.

The AR meta-information 100 has position information 101, date and time information 102, a title text 103, icon acquisition location information 104, and one or more pieces of position relevant information 110, and has a data type 111, data acquisition location information 112 and data date and time information 113 for each of the position relevant information 110.

The position information 101 stores position information about a real world to which the AR tag is attached, and generally uses position information of a GPS satellite and position information obtainable from a wireless LAN access point or a mobile phone network.

The date and time information 102 holds date and time information when the AR tag is generated and the updated date and time information.

The title text 103 is a descriptive character string of the AR tag which is used when the AR tag is displayed as a text as shown in FIG. 2, and generally stores a name and the like of an object which exists in a place indicated by the position information 101. The AR tag is occasionally displayed by a pictograph such as an icon considering ease of understanding, and in such a case, graphics data of the icon is acquired from an URL described in the icon acquisition location information 104, and displayed on the screen.

The position relevant information 110 is information for holding various relevant data which are linked to the position information 101 as links, and the data acquisition location information 112 describes a URL from which relevant data is acquired, and the date and time information 113 of data holds date and time when the position relevant information 110 was generated and the updated date and time.

As a type of data that can be linked as relevant data, it is considered there are various formats such as a Web page, a still image, a video, a voice file, metadata, a text, Office documents, an electronic book, a Widget, a script and an application program, but the content display device 50 does not always have ability capable of presenting all relevant data. Therefore, a data format (such as MIME-Type) of data to be acquired is described by the data type 111, so that the content display device 50 can extract only relevant data that one can present in the AR tag.

The content display device 50, when the AR tag is selected on the display screen, uses presentable relevant data, and can display various information about an object at that position that is linked to the position information as shown in FIG. 3.

Then, the stream AR information 300 which links video of video content to the AR meta-information 100 of the real world is described with reference to FIG. 1. Also, the stream AR information 300 is generally described as metadata in an XML format but may be in a binary format.

The stream AR information 300 can be held in plural for one video content or broadcasting program and has information such as a title text 301, acquisition location information 302 of the AR meta-information, interpolation scheme information 303, a start time 304, tag position information 305 on a video at the start time, tag depth information 306 on the video at the start time, end time 307, tag position information 308 on a video at the end time, tag depth information 309 on the video at the end time, a control point time 310, tag position information 311 on the video at the control point time, and tag depth information 312 on the video at the control point time.

The title text 301 is a name of the AR tag on the video content, and the acquisition location information 302 of the AR meta-information shows an URL of the AR meta-information 100 of the AR tag on the video content. Information other than the above is information showing, which time range and which position the AR tag is displayed, on the video content, and time information is described in relative time from the start point of the video.

That is to say, the AR tag is displayed during a period from the start time 304 to the end time 307 of the video content, and the display position on the screen is indicated by the X and Y coordinates of a pixel position on the video image and displayed while moving in a video frame unit from the tag position information 305 on a video at the start time to the tag position information 308 on the video at the end time. The AR tag position between the start position and the end position is determined by interpolating by calculating. The interpolation method is described in the interpolation scheme information 303. As a system for interpolation, there are considered linear interpolation, two-dimensional Bezier curve interpolation, three-dimensional Bezier curve interpolation and other systems. For the linear interpolation, only information on start time and end point is needed, and the control point time 310, the tag position information 311 on the video at the control point time and the tag depth information 312 on the video at the control point time are unnecessary.

For the two-dimensional Bezier curve interpolation, one piece of information of control point is designated, for the three-dimensional Bezier curve interpolation, two pieces of control point information are designated, each of them has start time, end point, control point's X and Y coordinates, and time T determined as parameters, a curve passing through them is created, and the AR tag is displayed at an X-Y coordinate position at the time of each video frame, so that the AR tag of the real world can be displayed synchronously on the video content.

And, for the tag depth information 306 on the video at the start time, the information 309 of the tag depth on the video at the end time and the tag depth information 312 on the video at the control point time, information indicating a depth position of the AR tag at respective positions is described by information necessary for the video of the stereoscopic display.

This depth information is considered to describe by relative position information (such as a percentage of a distance from the nearest plane to the furthest plane) from the depth position of the nearest plane of the stereoscopic video to the depth position of the furthest plane.

Also, the video content is not a continuation of all videos but often configured by connecting a plurality of continuous cuts. The AR tag of this embodiment displays by interpolating between the start time and the end point, so that there are cut points between the start time and the end point, and if the viewpoint changes discontinuously, there is a problem that the AR tag cannot be interpolated along the video.

In such a case, even if the AR tag is same, the problem can be avoided by dividing the stream AR information 300 for each continuous scene and describing separately.

For information of the depth position of the nearest plane and the depth position of the furthest plane of the stereoscopic video, there are considered a system to describe in SI information multiplexed into the video content or header information of video packet, and a system to transmit by metadata different from the video content.

Also, a video content which is not stereoscopic but two-dimensional describes depth information sometimes. In this case, stereoscopic expression is not performed on the video but depth information is regarded as a distance from the user, the AR tag which is deep on the video and exists far has small characters and icons and when the depth becomes smaller, the AR tag is displayed to have characters and icons becoming larger gradually, and for the two-dimensional video content, it becomes easy to grasp a positional relationship of the object of which AR tag is displayed. The depth information of this case does not really perform stereoscopic display, so that there is no problem in practice if the positional relationship of relative depth is known.

FIG. 8, FIG. 9 and FIG. 10 are display images of AR tag service in the video content of the content display device described above.

In this example, a display screen 500 reproduces a video displaying a straight road from this side to the distance and buildings along either side of the road, and in the screen, a first AR tag position in the scene of a building 501 surrounded by a thick line is 501, the AR tag position last in the scene is 503, and the AR tag position at a middle control point is 502, interpolation is made between 501 and 503 by a two-dimensional Bezier curve, and the AR tag is continuously displayed at an interpolation position of the frame between them. In this example, depth information of the display position of the AR tag is also referred to, and the AR tag is displayed small at the distance and increasingly displayed as it comes closer.

The display device capable of displaying stereoscopically can realize display with the object and the AR tag on the video in a combined form by varying a size of the AR tag and also varying a depth of the stereoscopic display.

By selecting the AR tag during the playback of the video content, the AR information screen 400 shown in FIG. 3 is displayed, various pieces of information of the AR tag that is linked to the object on the video can be viewed.

It is considered to select the AR tag by a cursor button of a remote controller, a pointing device such as a mouse, or a display device-integrated touch panel.

The AR information screen 400 of FIG. 3 displays relevant information of the AR tag on another screen independent of the video playback, but relevant information of the AR tag may be displayed at the same time as in FIG. 11 while playing back the video as a slave screen of the AR information screen 400, or relevant information of the AR tag may be displayed at the same time while playing back the content video 500 with the screen divided as in FIG. 12.

In addition, while the video content is played back as in FIG. 13, the AR information screen 503 may be displayed in a form interposed thereon. In this example, a display area is small, and all information cannot be displayed at one time, the AR information screen 503 can be displayed by scrolling by upper and lower scroll buttons 504 and 505.

A processing flow 1000 for realizing the display of the AR information screen described above when broadcasting is received is shown in FIG. 14.

For broadcasting, when the content display device is powered on, broadcasting is always received, and video is displayed. Here, just after a program which can be identified by SI information is started, the stream AR information 300 of the viewing/listening program is acquired (1010).

There is a system that the stream AR information 300 is multiplexed to contain in the video content as part of the SI information. Otherwise, it is also conceivable to have a system that only URL information of the stream AR information 300 on the Internet is multiplexed in the SI information and acquired from the metadata server 62 according to the described URL information.

When the stream AR information 300 was acquired, its information is analyzed to form a list showing which time zone and which position the AR tag must be displayed during the relative time from the start time of the program, and the corresponding AR meta-information 100 is acquired according to the acquisition location information 302 of the AR meta-information (1020).

Then, the interpolation position of the AR tag is calculated from the stream AR information 300 according to the designated interpolation scheme (1030).

Subsequently, while the video of the program is played back, display of the AR tag is started according to the time designated by a relative time from the start of the program designated by the stream AR information 300, and processing for movably displaying according to the interpolation position is performed in parallel with a plural pieces of stream AR information 300 (1040).

When the AR tag is displayed and the AR tag is selected by the operation device (1050), the AR information screen related to the AR tag is displayed (1060).

Also, there might be a case that the AR meta-information 100 which is designated by the acquisition location information 302 of AR meta-information of the stream AR information 300 does not exist or cannot be acquired within a prescribed time, or a case that the AR meta-information 100 can be acquired, but relevant data indicated by the position relevant information 110 does not exist or cannot be acquired within a prescribed time.

In the above case, the AR tag is determined not to be displayed considering user's convenience, and the AR tag may be displayed when relevant data can be acquired by retrying.

When the AR information screen is terminated by operating the operation device, the video display of the original program is resumed.

According to the above embodiment, the broadcasting is received by the content display device 50, the program video of the broadcasting is played back, and the AR tag of the real world can be displayed in linkage with the object displayed in the video, thus enhancing convenience.

And, if the content display device 50 is provided with a stereoscopic video display function, a stereoscopic video is displayed, and AR tag stereoscopic display may be made thereon. In such a case, the stream AR information 300 is described thereon the tag depth information 306 on the video at the start time, the tag depth information 309 on the video at the end time, and the tag depth information 312 on the video at the control point time, and when the AR tag is to be displayed, video depth of the AR tag on a frame in the middle is determined by performing interpolation in step 1040 in the same manner as the tag position information, and according to the determined video depth, the AR tag may be displayed by composing on the video.

### Embodiment 2

Embodiment 2 describes a system in that a video content is received on demand from the content server 63 on the network, and an interlocked AR tag is displayed while playing back.

A content transmission/reception system, a distribution system, and a content display device 50 have the same structure as in Embodiment 1, and the used AR meta-information 100 and stream AR information 300 also have the same structure example as in Embodiment 1.

The screen display examples of FIGS. 8-10 are also same as those in Embodiment 1, but Embodiment 1 distributes the stream AR information 300 in a unit of broadcasting program which is always flowing, but Embodiment 2 is different on a point that the stream AR information 300 is distributed in a unit of video content to be distributed on demand from the content server 63.

In Embodiment 2, the content display device 50 executes its mounted Web browser software to display a Web site acquired from the Web server 61 and operates as exemplified in FIG. 15.

As in the example of FIG. 15, playback of the video content is started by selecting a link for “Performs playback of a video” displayed on the Web site.

At this time, the playback control metafile 200 is designated by link information of the video content, and the Web browser obtains and analyzes the playback control metafile 200, and plays back the video content on demand according to the playback control metafile 200.

FIG. 16 is a structure example of the playback control metafile 200.

The playback control metafile 200 consists of three pieces of information such as content-specific attribute information 210 which is information of an AV stream of the content itself necessary at the time of content playback, license acquisition information 220 which is necessary at the time of acquiring a key or the like for decrypting the code of the encrypted content, and network control information 230 which is necessary to perform the playback control of the streaming VOD.

The playback control metafile 200 is generally described as metadata in an XML format but may be in a binary format.

The content-specific attribute information 210 provides title information 211 of the video content, a reference destination URL 212 of the video content, a content time length 213, attribute information 214 of a video signal such as a video coding method, resolution, scanning and aspect ratio, attribute information 215 of a voice signal such as stereophonic/monophonic/multichannel differentiation, and stream AR information acquisition location information 216.

The stream AR information acquisition location information 216 describes a URL to obtain from the Internet the stream AR information 300 about the video contents to be played back.

The content license acquisition information 220 provides information such as copyright management server address information 221 which becomes a license acquisition location of an object content, type information 223 of a copyright management scheme, a license ID 224 which shows a type of copyright protection range associated with the content, a signing object element value 222 and a reference destination 226 to perform server authentication between a copyright management server and a client receiver, license use condition information 225, and a public key certificate 227 which is necessary for verification of a signature.

The network control information 230 describes information 231 of a usable streaming protocol type. And, it also describes streaming server function information 232 which prescribes various functions of streaming playback such as if it is possible to perform special playback, finding of the beginning of the content, or resume of the paused playback from the interrupted point. In addition, if variable speed playback at multiple stages is possible by server functions, information 233 which shows a magnification at each stage and information 234 of its playback method are described.

As the playback method, there are a method that distributes a stream dedicated for variable speed playback by preparing it by the server side, and a method that realizes high speed playback in a pseudo manner by performing playback by skipping still images included in the stream of normal speed playback.

FIG. 17 is a processing flow 1100 of streaming playback of an on-demand video.

This processing flow is different from a broadcast reception processing flow 1000 on the points that when the Web content acquired from the Web server 61 is presented by a Web browser, a video content desired to be viewed is selected, and playback is instructed (1001), the playback control metafile 200 linked from the Web site is first acquired from the metadata server 62 (1005); the stream AR information 300 is acquired from the metadata server 62 according to the URL of the stream AR information acquisition location information 216 described in the playback control metafile 200 (1010); and streaming playback of the video is started after an interpolation position of the AR tag is calculated and display of the AR tag is prepared (1035).

In addition, when playback of the video content is completed, streaming playback is terminated (1070), and display of the Web browser is resumed.

The display control of the AR tag during the playback of the video content is the same as the processing flow 1000.

According to the above embodiment, the streaming playback of the on-demand video which is distributed via the network can also be displayed similar to the broadcasting with the AR tag of the real world in linkage with the object displayed in the video.

### Embodiment 3

Embodiment 3 describes a system which displays an interlocked AR tag by receiving video contents from the content server 63 on the network on demand to accumulate in the storage 14, while playing back the accumulated video contents, with reference to mainly differences from Embodiment 2.

A link 605 for “Download a video” is selected in a Web browser screen 600 of FIG. 15 of Embodiment 2 to download the relevant video content.

After downloading, a downloaded content can be viewed/listened by selecting the content on an accumulated content list screen 800 as shown as an example in FIG. 18.

The accumulated content list screen 800 displays, for the contents accumulated or being accumulated, a thumbnail video or still image 801 of the contents, a title character string 802 of the contents, and a playback button 803 of the video contents. And, when a playback button 603 for a content which is desired to see is selected, an AR tag attached video content is played back as shown in FIGS. 8-10.

FIG. 19 is a structure example of a download control metafile 700 which is used for download processing of the video content. The download control metafile 700 includes download control attribute information 710 which describes the contents of the metafile itself, and download execution unit information 750 which is used to download one or plural contents collectively.

Also, the download control metafile 700 is generally described as metadata in an XML format but may be in a binary format.

The download control metafile 700 is described by, for example, an RSS (RDF Site Summary or Really Simple Syndication). The download control metafile 700 is occasionally updated, and a receiver checks at a prescribed period and updates a difference.

The download control attribute information 710 has information such as a download control information name 711 showing a name (for example, a download reservation name, a file name, ID, etc.) of the corresponding download control metafile 700, acquisition location information 712 of the download control information showing an URL of an acquisition location of the download control metafile 700, a description text 713 of the download control information indicating a description (for example, description, language type, etc. for the download reservation) of the corresponding download control metafile 700, an update check flag 714, and an update time limit date and time 715.

The update check flag 714 is a flag for identifying whether a periodical check is performed to see if the contents of the download control metafile 700 on the metadata server 62 were changed, and takes a value for “update” to perform checking, and after obtaining first, takes a value for “one time” not to perform checking periodically. The update time limit date and time 715 is valid when the update check flag 714 is “update”, and describes the date and time for the time limit during which the update of the download control metafile 700 is continued to check.

The update time limit date and time 715 indicates a time limit for monitoring the content update. The unit (such as unit of date, unit of time, and unit of minute) of time limit is arbitrary. It is also possible to take a value indicating “no time limit” or continuing the check almost permanently. And, as another implementation method, a structure in which the update check flag 714 is omitted can also be realized by handling a special value (for example, all 0) of the update time limit date and time 715 as a value indicating “one time” of the update check flag 714.

The download execution unit information 750 can be described in plural in the download control metafile 700. For individual contents to be downloaded, information such as a distribution content title 751 showing a title (which may be a program name or the like, a file name or ID) of the content, a distribution content description text 752 showing a description (features, remarks, etc.) of the content, distribution date and time 753 showing date and time (which may be date unit, minute unit) for distribution of the content, a content ID 754 of the distribution content for uniquely identifying the content on the Internet, a distribution content type 755, content acquisition location information 756 showing an acquisition location URL of the distribution content, ECG metadata acquisition location information 757 showing acquisition location URL of ECG metadata corresponding to the content, playback control metafile acquisition location information 758 showing acquisition location URL of the playback control metafile 200 corresponding to the content, and a distribution content size 759 are stored.

The distribution date and time 753 describes normally date and time when the content is stored in the content server 63 and when the download control metafile 700 is distributed, the content is not made public yet, and future date and time when distribution is scheduled may be described in the distribution date and time 753. And, when any part of the distributed content is updated once, the updated date and time are described in the distribution date and time 753.

The distribution content type 755 describes, for example, types such as video, photograph, music, program, multimedia data distributed from the server. Types may be described by further subdividing the video to movie, news, sports, etc., and further subdividing the music to classic, rock, jazz, etc.

The playback control metafile 200 instructed by the playback control metafile acquisition location information 758 may be basically same as in Embodiment 2, but the network control information 230 is not used for the download content and may not be provided.

FIG. 20 is a flow chart 1200 of download processing of the video content on the content display device 50.

When the Web content acquired from the Web server 61 is presented by the Web browser to select a video content to be viewed and download is instructed (1210), the download control metafile 700 linked to the download button is acquired from the metadata server 62 and analyzed its contents (1220); the ECG metadata of the video content to be downloaded is acquired according to the acquisition location information 757 of the ECG metadata of the download control metafile 700 and accumulated in the storage 14 (1230); the playback control metafile 200 is acquired according to the acquisition location information 758 of the playback control metafile of the download control metafile 700 and accumulated in the storage 14 (1240); and the video content body is downloaded according to the distribution content acquisition location information 756 of the download control metafile 700 and accumulated in the storage 14 in linkage with the ECG metadata and the playback control metafile 200 (1250).

The plural pieces of download execution unit information 750 can be described in the download control metafile 700, and when the plural pieces of download execution unit information 750 are described, all of ECG metadata, playback control metafile 200 and the content body are acquired for the respective video contents.

The accumulated video content and the video content being accumulated are displayed on the screen of the accumulated content list 800 of FIG. 18, and when playback of a video is instructed on this screen, the video is played back according to an accumulated video playback processing flow 1300 of FIG. 21.

Here, the accumulated video playback processing flow 1300 is different from the streaming processing 1100 of Embodiment 2 on the following points.

(1) The playback control metafile 200 is acquired directly from the metadata server 62 by the streaming processing 1100, while the content body and also the playback control metafile 200 are acquired and accumulated by the accumulated video playback processing flow 1300, so that the playback control metafile 200 is read from the storage 14 when the content is played back (1310).
(2) The streaming processing 1100 performs streaming playback while directly acquiring the video content from the content server 63, while the accumulated video playback processing flow 1300 reads and reproduces the video content from the storage 14 (1320).
(3) The streaming processing 1100 terminates the streaming processing at the end of the video content and returns to the Web browser screen, while the accumulated video playback processing flow 1300 returns to the screen of the accumulated content list 800 when the video playback from the storage 14 is completed (1330).

Processing to display the AR tag while playing back the video is quite the same as that in Embodiment 2.

According to the above embodiment, when the video content which is network-distributed is downloaded into the storage and the video content is played back from the storage, the AR tag of the real world can be displayed in linkage with the object displayed in the video similar to the streaming video playback.

In Embodiment 3, it was described in the example that the video content was downloaded through the network and accumulated in the storage, but when a broadcasting program is recorded and accumulated in the storage and SI information is also accumulated, and the recorded program is played back from the storage, the AR tag can be displayed in linkage with the recorded broadcasting content similar to real-time broadcasting by using the stream AR information included in the program similar to the processing flow 1000.

Also, the present invention is not limited to the above-described embodiments but includes various modifications. For example, the above-described embodiments are described in detail to explain the present invention in such a way that it is easily understood and not necessarily limited to one which is provided with all the described structures. And, the structure of a certain embodiment can be partly replaced by the structure of another embodiment, and it is also possible to add the structure of another embodiment to the structure of a certain embodiment. And, it is possible that a part of the structure of each embodiment is made to have addition, deletion or substitution of another structure.

And, the above-described respective structures, functions, processing parts, processing means, etc. may have part or all of them realized by hardware by designing, for example, an integrated circuit or the like. And, the above-described respective structures, functions and others may be realized by software by interpreting and executing the programs for realizing the respective functions by a processor. Information such as programs, tables, and files for realization of respective functions can be placed on a recording device such as memories, hard disks, or SSDs (Solid State Drives), or recording media such as IC cards, SD cards, or DVDs.

And, control lines and information lines shown are those considered to be necessary for the description, and all control lines and information lines are not necessarily shown in view of products. In actuality, it may be considered that almost all structures are mutually connected.

### REFERENCE SIGNS LIST

50: Content display device, 100: AR meta-information, 300: Stream AR information, 400: AR information screen, 453: AR tag, 600: Web browser screen

1. A reception device for displaying an AR tag which can be presented by selecting information that is related to an object of a video image to be displayed together with a video image, wherein:
video image information and AR information, which has the AR tag, acquisition location information enabling the acquisition of information related to the object by accessing a server holding the information, time information about the start to end of a video image, and position information indicating the display position of the AR tag in the video image of each of the time information, are transmitted,
the reception device is provided with:
a receiving part for receiving the video image information and the AR information which are transmitted,
a display part for displaying the video image based on the received video image information,
a control part for displaying the AR tag by superimposing it on the displayed object of video image based on the time information and the position information in the received AR information, and
a communication IF for acquiring information that is related to the object by accessing the server based on the acquisition location information; and
the control part, when the displayed AR tag is selected, displays the information that is related to the object on which the selected AR tag is superimposed.

2. The reception device according to claim 1, wherein:
the video image information is transmitted by broadcasting,
the receiving part for receiving the transmitted video image information is a broadcasting IF, and
the video image information received by the broadcasting IF is displayed in real time by the display part or displayed by being recorded and played back.

3. The reception device according to claim 1, wherein:
the video image information is transmitted by communications,
the receiving part for receiving the transmitted video image information is a communication IF, and
the video image information received by the communication IF is displayed by streaming by the display part or displayed by downloading.

4. The reception device according to claim 2, wherein:
the AR information is transmitted by being multiplexed in the video image information by broadcasting and received by the broadcasting IF.

5. The reception device according to claim 1, wherein:
the AR information is transmitted by communications, and
the receiving part for receiving the transmitted AR information is a communication IF.

6. The reception device according to claim 1, wherein:
the AR information further has depth information related to a depth direction of a video image of each of the time information, and
the control part displays the AR tag to be superimposed while reducing its size as the object tends to become deeper based on the depth information.
